(19) United States
(12) Patent Application Publication
(10) Pub. No.: US 2008/0156434 A1
(43) Pub. Date: Jul. 3, 2008

(54) DOUBLE-SIDED MOUNTING APPARATUS AND ELECTRIC DEVICE MANUFACTURING METHOD

(76) Inventors: Yoshitaka Uematsu, Yokohama-shi (JP); Sei Musha, Kawasaki-shi (JP); Hironori Takabayashi, Yokohama-shi (JP); Toshihiko Goshozono, Yokosuka-shi (JP); Emiko Nakagawa, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/931,838

(22) Filed: Oct. 31, 2007

(30) Foreign Application Priority Data
Oct. 31, 2006 (JP) 2006-297154

(51) Int. Cl. B32B 37/06; B32B 38/10

(52) U.S. Cl. 156/306.3; 156/391

(57) ABSTRACT

A double-sided mounting apparatus includes a first pressure bonding tool and a second pressure bonding tool disposed opposite to each other, heating mechanism for heating the first pressure bonding tool and the second pressure bonding tool, pressing mechanism for applying pressure to an area between the first pressure bonding tool and the second pressure bonding tool, a work holding mechanism which holds a work item between the first and second pressure bonding tools, a first protective tape supply mechanism disposed between the first and second pressure bonding tools and used to supply a first protective tape to the first pressure bonding tool, and a second protective tape supply mechanism disposed between the first and second pressure bonding tools and used to supply a second protective tape to the second pressure bonding tool.

### CROSS-REFERENCE TO RELATED APPLICATIONS

This application is based upon and claims the benefit of priority from prior Japanese Patent Application No. 2006-297154, filed Oct. 31, 2006, the entire contents of which are incorporated herein by reference.

### BACKGROUND OF THE INVENTION

1. Field of the Invention

The present invention relates to a double-sided mounting apparatus and an electric device manufacturing method, and particularly to a double-sided mounting apparatus for mounting electronic components on both sides of a mounting base, and an electric device manufacturing method using the double-sided mounting apparatus.

2. Description of the Related Art

As disclosed in Japanese Patent No. 3355983, a known mounting apparatus manufactures an electronic-component mounted device by mounting electronic components (e.g., ICs, LSIs, resistors or capacity elements) onto a mounting base such as a substrate. This electronic-component mounted device is manufactured in a manner as described below. A mounting tool is first prepared such that the electronic components are temporarily fastened to each mounting base via an anisotropic conductive film (ACF), which is an anisotropic conductive adhesive. Subsequently, the mounting tool is placed on the head of the mounting apparatus, the mounting tool placed on the head is pressed against it by a pressure bonding head, and the anisotropic conductive adhesive is heated.

However, the mounting apparatus described above is ill-considered in the respects described below. Recently, as electronic-component mounted devices have become more compact, mounting bases have become smaller, too. This narrows the electronic component mounting space of the mounting base. Therefore, if the number of electronic components to be mounted increases, the size of the mounting base must be increased accordingly. It is difficult to make the electronic-component mounted device more compact while at the same time increasing the number of electronic components to be mounted.

### BRIEF SUMMARY OF THE INVENTION

It is accordingly an object of the present invention to provide a double-sided mounting apparatus and a double-sided mounting method, which make it possible to make electronic-component mounted devices having mounted thereon a number of electronic components more compact while allowing an increase in the number of electronic components to be mounted on each mounting base.

A double-sided mounting apparatus of the present invention comprises: a first pressure bonding tool and a second pressure bonding tool disposed opposite to each other; heating means for heating the first pressure bonding tool and the second pressure bonding tool; pressing means for applying pressure to an area between the first pressure bonding tool and the second pressure bonding tool; a work holding mechanism which holds a work item between the first and second pressure bonding tools; a first protective tape supply mechanism disposed between the first and second pressure bonding tools and used to supply a first protective tape to the first pressure bonding tool; and a second protective tape supply mechanism disposed between the first and second pressure bonding tools and used to supply a second protective tape to the second pressure bonding tool.

An electric device manufacturing method of the present invention comprises: a step of temporarily fastening a first electronic component to a surface of a mounting base via a first anisotropic conductive adhesive, and temporarily fastening a second electronic component to the back of the mounting base, which is opposite to the surface, via a second anisotropic conductive adhesive; a step of disposing a first protective tape opposite to the first electronic component temporarily fastened, and disposing a second protective tape opposite to the second electronic component temporarily fastened; and a step of applying heat and pressure to the first anisotropic conductive adhesive via the first protective tape and the first electronic component, and applying heat and pressure to the second anisotropic conductive adhesive via the second protective tape and the second electronic component, thereby connecting the first and second electronic components to the surface and back, respectively, of the mounting base.

The present invention makes it possible to make electronic-component mounted devices having mounted electronic components on a mounting base more compact while allowing an increase in the number of electronic components to be mounted on each mounting base.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view schematically showing a double-sided mounting apparatus according to a first embodiment of the present invention;

FIG. 2 is a schematic side view of the double-sided mounting apparatus;

FIG. 3A is a side view of an example of a double-sided work item held by a work holding mechanism used in the double-sided mounting apparatus;

FIG. 3B is a side view of another example of the double-sided work item held by a work holding mechanism used in the double-sided mounting apparatus;

FIG. 4 is a flowchart illustrating a double-sided mounting steps;

FIG. 5 is a front view showing the state of step S2 of the double-sided mounting steps;

FIG. 6 is a front view showing the state of steps S3 and S4 of the double-sided mounting steps;

FIG. 7 is a front view showing the state of step S5 of the double-sided mounting steps;

FIG. 8 is a front view showing the state of step S6 of the double-sided mounting steps;

FIG. 9 is a front view showing the state of step S8 of the double-sided mounting steps;

FIG. 10 is a schematic side view of a double-sided mounting apparatus according to a second embodiment of the present invention;

FIG. 11 is a side view of a raising/lowering part the weight of which is canceled out by a weight canceling mechanism according to the second embodiment;

FIG. 12 is a side view of part of the double-sided mounting apparatus according to the second embodiment before pressures are applied to ICs and ACFs;

FIG. 13 is a side view of part of the double-sided mounting apparatus according to the second embodiment, in which an upper pressure bonding tool is in contact with the upper IC via a protective tape;

FIG. 14 is a side view of part of the double-sided mounting apparatus according to the second embodiment, in which the upper pressure bonding tool is further lowered after the upper pressure bonding tool has come into contact with the upper IC via the protective tape;

FIG. 15 is a side view of part of the double-sided mounting apparatus according to the second embodiment, in which the upper pressure bonding tool is further lowered and consequently the lower IC has come into contact with a lower pressure bonding tool via the protective tape;

FIG. 16 is a schematic side view of a double-sided mounting apparatus according to a third embodiment of the present invention;

FIG. 17 is a schematic view of the configuration of a floating mechanism according to the third embodiment;

FIG. 18 is a schematic view of the configuration of a modified example of the floating mechanism according to the third embodiment;

FIG. 19A is a schematic plan view of another modified example of the floating mechanism according to the third embodiment; and

FIG. 19B is a schematic view of the configuration of the modified example shown in FIG. 19A.

### DETAILED DESCRIPTION OF THE INVENTION

Embodiments of the present invention will be described with reference to the accompanying drawings.

### First Embodiment

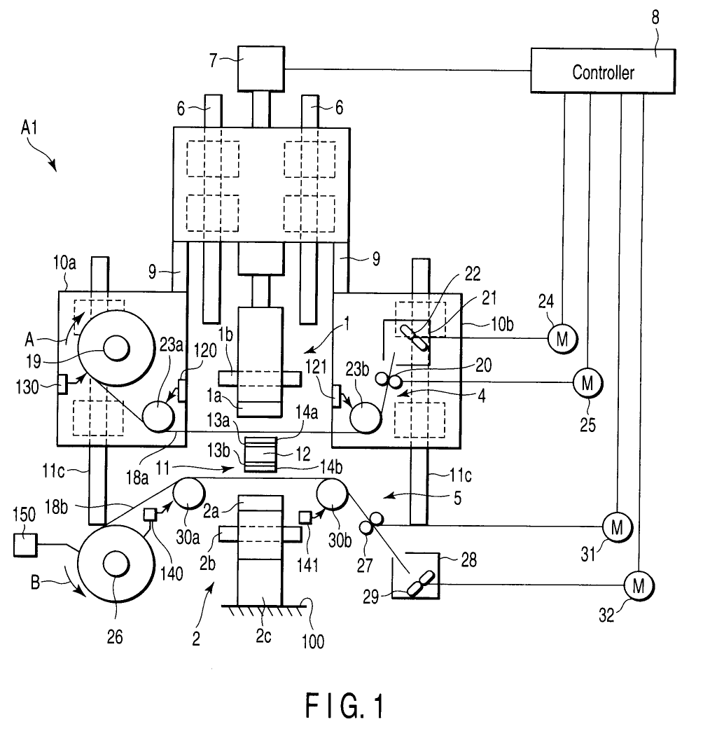

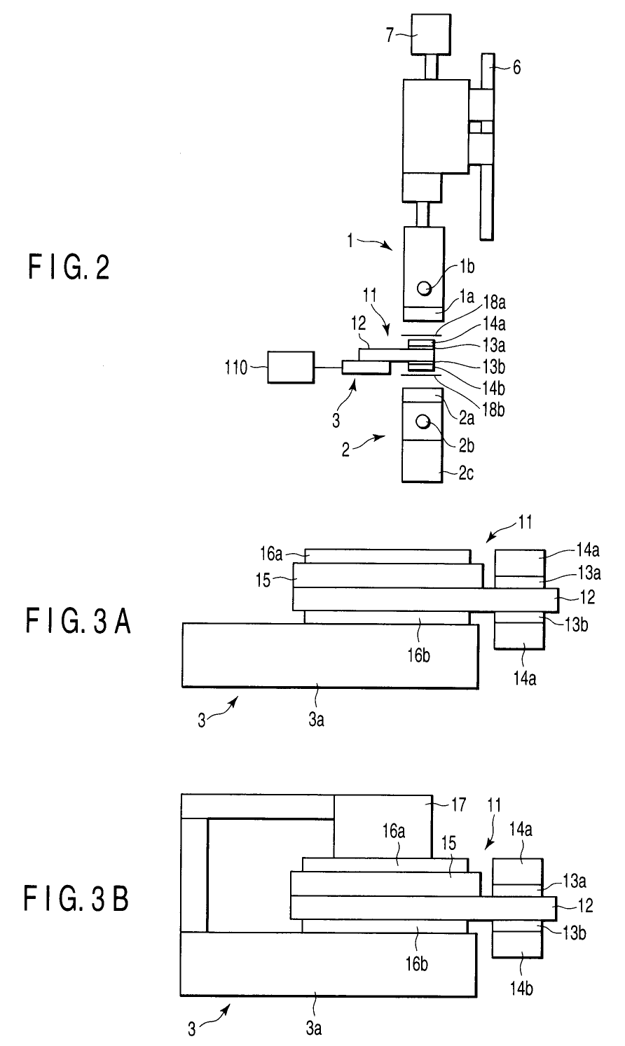

An double-sided mounting apparatus A1 according to the first embodiment includes, as shown in FIGS. 1 and 2: first and second pressure bonding tools 1 and 2 disposed vertically opposite to each other; a work holding mechanism 3; and first and second protective tape supply mechanisms 4 and 5.

The first pressure bonding tool 1 has a first pressing part 1a disposed opposite to the second pressure bonding tool 2, and a heating means, namely a heater 1b. The first pressing part 1a and the heater 1b are disposed so that heat generated by the heater 1b is transmitted to the first pressing part 1a.

The first pressure bonding tool 1 is mounted on vertically extending linear guides 6 so as to be vertically slidable along them. Connected to the first pressure bonding tool 1 is a vertical drive part 7, which moves the first pressure bonding tool 1 vertically along the liner guides 6.

An air cylinder, hydraulic cylinder, stepping motor, or the like may be used as the vertical drive part 7. The vertical drive part 7 is connected to a controller 8 that controls the vertical drive part 7. This vertical drive part 7 functions as a pressing means as well, which applies pressure to the area between the first pressure bonding tool 1 and second pressure bonding tool 2.

Also connected to the first pressure bonding tool 1 are a pair of frames 10a and 10b via corresponding connecting rods 9. The frames 10a and 10b are mounted on corresponding vertically extending linear guides 11c so as to be slidable. The linear guides 11c are disposed parallel to the linear guides 6 so that when the first pressure bonding tool 1 is vertically moved by the drive of the vertical drive part 7, the frames 10a and 10b are vertically moved integrally with the pressure bonding tool 1.

The second pressure bonding tool 2 has: a second pressing part 2a disposed opposite to the first pressing part 1a of the first pressure bonding tool 1; and a heating means, namely a heater 2a. The second pressing part 2a and the heater 2b are disposed so that heat generated by the heater 2b is transmitted to the second pressing part 2a. The second pressure bonding tool 2 is mounted on a pedestal 2c fixed to a base 100.

The work holding mechanism 3 holds a work item 11 to be mounted, between the pressing part 1a of the first pressure bonding tool 1 and the pressing part 2a of the second pressure bonding tool 2. The work holding mechanism 3 includes a raising/lowering mechanism 110, which moves the held work item 11 upward or downward from an initial position (i.e., the position intermediate between the first pressure bonding tool 1 and second pressure bonding tool 2 before they are driven).

The work item 11 to be mounted is configured such that a first electronic component, namely an IC 14a, is temporarily fastened to the surface of a mounting base 12 via a first anisotropic conductive adhesive, namely ACF 13a, and a second electronic component, namely IC 14b, is temporarily fastened to the back of the mounting base 12 via a second anisotropic conductive adhesive, namely ACF 13b.

FIGS. 3A and 3B show a liquid crystal display, which is an example of the work item 11. The configuration of the liquid crystal display is such that the IC 14a is temporarily fastened to the surface of the mounting base (glass substrate) 12 via the ACF 13a, and the IC 14b to the back of the mounting base 12 via the ACF 13b. Further, a glass substrate 15 is joined to the surface of the mounting base 12, a polarization plate 16a is joined to the glass substrate 15, and a polarization plate 16b is joined to the back of the mounting base 12.

A system for holding the work item 11 in the work holding mechanism 3 may be a system in which the polarization plate 16b adheres to a holding stage 3a, which is part of the work holding mechanism 3, as shown in FIG. 3A, or a system in which the work item 11 is clamped by a work clamper 17 attached to the holding stage 3a, as shown in FIG. 3B.

The first protective tape supply mechanism 4 includes: a first holding shaft 19, which is a first holding part for holding a first protective tape 18a in the form of a roll; first feed rollers 20, serving as a first supply part for drawing the first protective tape 18a from the roll and supplying it to a supply position; a first suction fan 22, serving as a first suction part for drawing the supplied first protective tape 18a into a first storage case 21; and a pair of guide rollers 23a and 23b. Connected to the first feed rollers 20 is a drive motor 24, and connected to the first suction fan 22 is a drive motor 25. These motors 24 and 25 are connected to the controller 8.

The first holding shaft 19 and the guide roller 23a are mounted in the one frame 10a. The guide roller 23b, the first feed rollers 20, the first storage case 21, and the first suction fan 22 are mounted in the other frame 10b. Thus, by vertically moving the first pressure bonding tool 1 together with the frames 10a and 10b by the drive of the vertical drive part 7, the first protective tape supply mechanism 4 is vertically moved integrally with the first pressure bonding tool 1.

Connected to the guide rollers 23a and 23b are vertical moving mechanisms 120 and 121 respectively, which vertically move only the guide rollers 23a and 23b. The first holding shaft 19 is provided with a torque limiter mechanism 130, which applies torque in the direction in which the held first protective tape 18a is wound back (the direction of arrow A shown in FIG. 1), thereby preventing slackening of the first protective tape 18a drawn from the roll.

The first protective tape supply mechanism 4, disposed between the first and second pressure bonding tools 1 and 2, supplies the first protective tape 18a toward the first pressure bonding tool 1. When the work item 11 held by the work holding mechanism 3 is positioned between the first and second pressure bonding tools 1 and 2, the first protective tape 18a is supplied to the area between the first pressure bonding tool 1 and the work item 11.

The first protective tape 18a is a roll of long Teflon™ tape. When the first and second pressure bonding tools 1 and 2 apply pressure to the work item 11 held between them, as described below, the first protective tape 18a drawn from the roll and supplied between the first pressure bonding tool 1 and the work item 11 prevents any ACF 13a thus extruded from sticking to the pressing part 1a of the first pressure bonding tool 1, prevents any IC 14a from coming into contact with the metal pressing part 1a, and functions as a cushion that makes uniform the pressure exerted on the IC 14a of the work item 11 by the first pressure bonding tool 1.

In the first protective tape supply mechanism 4, the first protective tape 18a held by the first holding shaft 19 is drawn from the roll by driving the first feed rollers 20. The first protective tape 18a drawn from the roll stops temporarily between the first pressure bonding tool 1 and the work item 11 when the drive of the first feed rollers 20 temporarily stops. During the application of pressure to the work item 11, the first protective tape 18a is sandwiched between the pressing part 1a of the first pressure bonding tool 1 and the IC 14a of the work item 11.

After the application of pressure to the work item 11 is completed, the first feed rollers 20 are driven again in the same direction, the first protective tape 18a is conveyed toward the first storage case 21, then passed between the first feed rollers 20, subsequently sucked by the first suction fan 22, and accommodated in the first storage case 21.

The second protective tape supply mechanism 5 includes: a second holding shaft 26, which is a second holding part for holding a second protective tape 18b in the form of a roll; second feed rollers 27, serving as a second supply part for drawing the second protective tape 18b from the roll and supplying it to a supply position; a second suction fan 29, serving as a second suction part for drawing the supplied second protective tape 18b into a second accommodating case 28; and a pair of guide rollers 30a and 30b. Connected to the second feed rollers 27 is a drive motor 31, and connected to the second suction fan 29 is a drive motor 32. These motors 31 and 32 are connected to the controller 8.

The second holding shaft 26, the second feed rollers 27, the second storage case 28, the second suction fan 29, and the guide rollers 30a and 30b are mounted on the base, on which the second pressure bonding tool 2 is mounted. Connected to the guide rollers 30a and 30b are vertical moving mechanisms 140 and 141 respectively, which vertically move only the guide rollers 30a and 30b. The second holding shaft 26 is provided with a torque limiter mechanism 150, which applies torque in the direction in which the held second protective tape 18b is wound back (the direction of arrow B shown in FIG. 1), thereby preventing slackening of the second protective tape 18b drawn from the roll.

The second protective tape supply mechanism 5, disposed between the first and second pressure bonding tools 1 and 2, supplies the second protective tape 18b toward the second pressure bonding tool 2. When the work item 11 held by the work holding mechanism 3 is positioned between the first and second pressure bonding tools 1 and 2, the second protective tape 18b is supplied to the area between the second pressure bonding tool 2 and the work item 11.

The second protective tape 18b is a roll of long Teflon™ tape. When the first and second pressure bonding tools 1 and 2 apply pressure to the work item 11 held between them, as described below, the second protective tape 18b drawn from the roll and supplied between the second pressure bonding tool 2 and the work item 11 prevents any ACF 13b thus extruded from sticking to the pressing part 2a of the second pressure bonding tool 2, prevents any IC 14b from coming into contact with the metal pressing part 2a, and functions as a cushion that makes uniform the pressure exerted on the IC 14b of the work item 11 by the second pressure bonding tool 2.

In the second protective tape supply mechanism 5, the second protective tape 18b held by the second holding shaft 26 is drawn from the roll by driving the second feed rollers 27. The second protective tape 18b drawn from the roll stops temporarily between the second pressure bonding tool 2 and the work item 11 when the drive of the second feed rollers 27 temporarily stops. During the application of pressure to the work item 11, the second protective tape 18b is sandwiched between the pressing part 2a of the second pressure bonding tool 2 and the IC 14b of the work item 11.

After the application of pressure to the work item 11 is completed, the second feed rollers 27 are driven again in the same direction, the second protective tape 18b is conveyed toward the second storage case 28, then passed between the second feed rollers 27, subsequently sucked by the second suction fan 29, and stored in the second storage case 28.

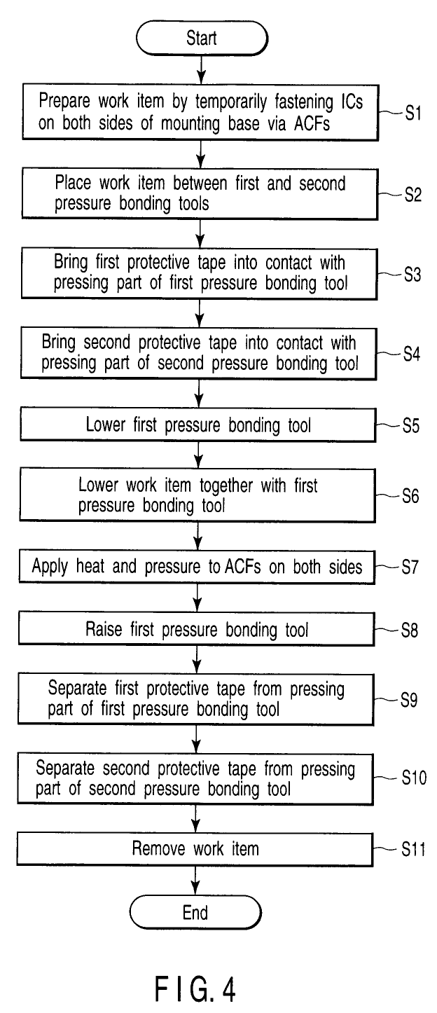

A double-sided mounting method using the double-sided mounting apparatus A1 will now be described with reference to a flowchart shown in FIG. 4 and FIGS. 5 to 9.

First, a work item 11 is formed by temporarily fastening, via the ACF 13a, the IC 14a on the surface of the mounting base 12 and then temporarily fastening, via the ACF 13b, the IC 14b on the back of the mounting base 12, which is opposite to the IC 14a thus temporarily fastened (S1).

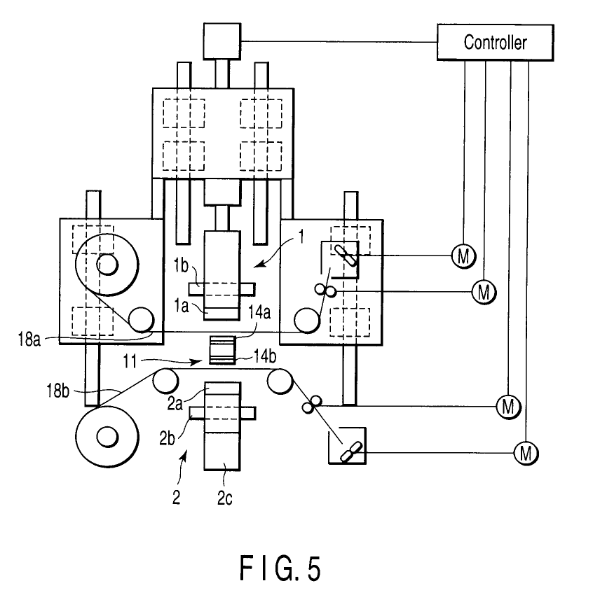

Subsequently, the work item 11 thus prepared is held between the first and second pressure bonding tools 1 and 2 by the work holding mechanism 3. In addition, the IC 14a and IC 14b are disposed opposite to the first protective tape 18a and second protective tape 18b, respectively (S2). FIG. 5 is a front view showing the state of step S2.

In step S2, the first protective tape 18a and second protective tape 18b are located apart from the pressing part 1a of the first pressure bonding tool 1 and the pressing part 2a of the second pressure bonding tool 2, respectively. This prevents heat from the heaters 1b and 2b from being transferred to the first and second protective tapes 18a and 18b via the pressing parts 1a and 1b, respectively, with the result that the first and second protective tapes 18a and 18b are prevented from being shrunk or deformed by the heat before the first and second pressure bonding tools 1 and 2 apply pressure to the tapes 18a and 18b, respectively.

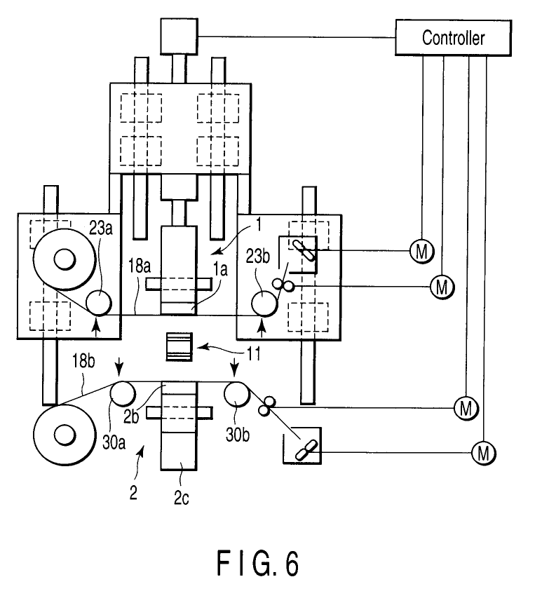

After the work item 11 is disposed between the first and second pressure bonding tools 1 and 2 via the first and second protective tapes 18a and 18b, the guide rollers 23a and 23b are raised, thereby bringing the first protective tape 18a into contact with the pressing part 1a of the first pressure bonding tool 1 (S3). In addition, the guide rollers 30a and 30b are lowered, thereby bringing the second protective tape 18b into contact with the pressing part 2a of the second pressure bonding tool 2 (S4). FIG. 6 is a front view showing the state of steps S3 and 4.

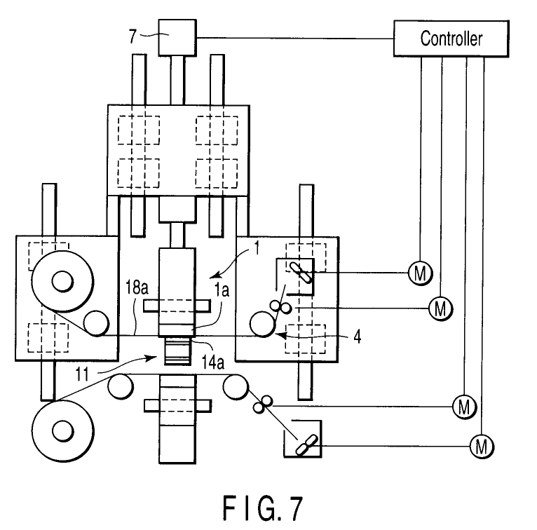

Subsequent to steps S3 and 4, the vertical drive part 7 is driven, thereby lowering the first pressure bonding tool 1 (S5). At this time, the first protective tape supply mechanism 4 and the first protective tape 18a are lowered integrally. FIG. 7 shows the front view of the state in which the first pressure bonding tool 1 has been lowered, and the pressing part 1a has been lowered onto the IC 14a of the work item 11 via the first protective tape 18a.

When brought into contact with the IC 14a, the first protective tape 18a has already been in contact with the pressing part 1a so that the positional relationship between the first protective tape 18a and pressing part 1a is stable. This prevents the first protective tape 18a brought into contact with the IC 14a from being subject to tension from the pressing part 1a. Accordingly, the first protective tape 18a is prevented from being displaced sidewise by such tension and also the temporarily fastened IC 14a from being displaced sidewise by the first protective tape 18a brought into contact with the IC 14a.

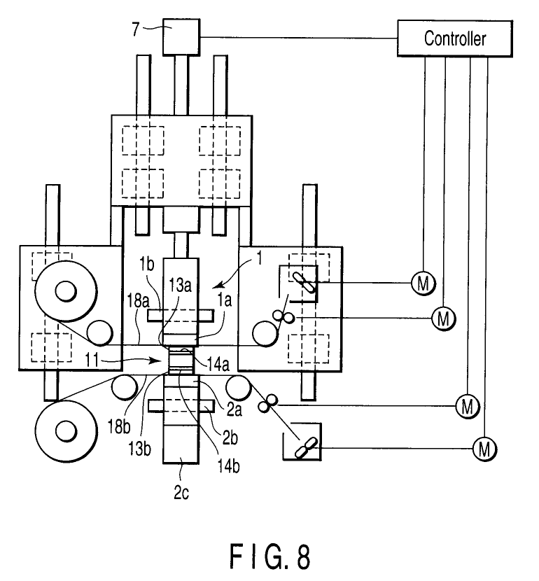

After the first pressure bonding tool 1 is lowered such that the pressing part 1a of the first pressure bonding tool 1 is brought into contact with the IC 14a via the first protective tape 18a, the first pressure bonding tool 1 is further lowered. Consequently, the first pressure bonding tool 1 depresses the work item 11 downward, held on the work holding mechanism 3, such that the work item 11 and the first pressure bonding tool 1 are integrally lowered (S6). FIG. 8 is a front view showing the state in which the lowered work item 11 has been brought into contact with the pressing part 2a of the second pressure bonding tool 2 via the second protective tape 18b.

After the work item 11 is lowered to the position shown in FIG. 8, such that the first and second pressure bonding tools 1 and 2 sandwich the ICs 14a and 14b of the work item 11 from above and below, the vertical drive part 7 is continuously driven. Thereby, the ACF 13a is pressed via the IC 14a, and the heat of the heater 1b is transmitted to the ACF 13a via the pressing part 1a and IC 14a. The ACF 13a is thus pressed and heated.

At the same time, the ACF 13b is pressed via the IC 14b and the heat of the heater 2b is transmitted to the ACF 13b via the pressing part 2a and IC 14b, so that the ACF 13b is pressed and heated (S7). The state of step S7 is shown in FIG. 8, which also shows the state of step S6. The ACFs 13a and 13b cause a thermoplastic reaction by the application of pressure and heat in step S7, so that the temporarily fastened ICs 14a and 14b are mounted on the mounting base 12.

Accordingly, the work item 11 acquires mounting spaces on both sides of the mounting base 12 and more such electronic components as the ICs 14a and 14b can be mounted on the mounting base 12 without increasing the size of the mounting base 12. This makes it possible to increase the number of electronic components to be mounted, while achieving a more compact work item 11.

Additionally, this mounting method makes it possible to apply the same degree of pressure and of heat to the ACFs 13a and 13b used for sticking the ICs 14a and 14b to both sides of the mounting base 12, thereby preventing application of insufficient or excessive pressure or heat. In this mounting method, the time taken for double-sided mounting is substantially the same as that taken for an electronic component to be mounted on a single side of the mounting base 12.

Next, after the first and second pressure bonding tools 1 and 2 have applied pressure and heat to the ACFs 13a and 13b for a predetermined length of time, the vertical drive part 7 is driven to raise the first pressure bonding tool 1 together with the first protective tape supply mechanism 4 (S8). As the first pressure bonding tool 1 is raised, the work item 11 held via the vertically freely movable mechanism is also raised, so that the IC 14b is separated from the second protective tape 18b.

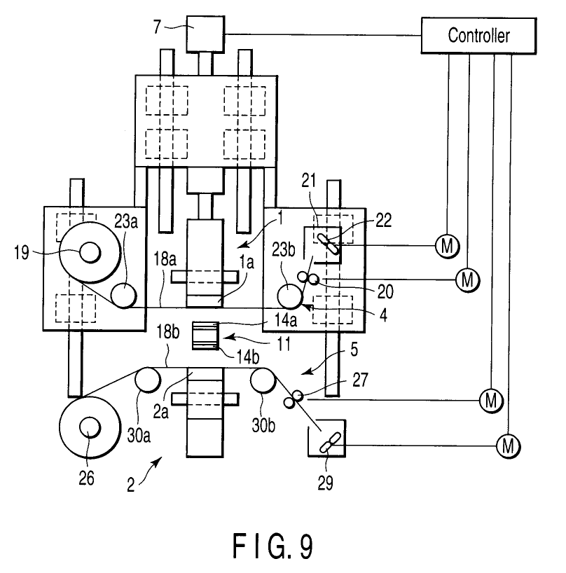

After the work item 11 is raised to the initial position (the position shown in FIGS. 6 and 7) together with the first pressure bonding tool 1, the raising of the work item 11 is stopped but raising of the first pressure bonding tool 1 continues. Consequently, the first protective tape 18a is separated from the IC 14a. FIG. 9 shows a front view in which the first and second protective tapes 18a and 18b are separated from the ICs 14a and 14b, respectively.

After the separation of the first and second protective tapes 18a and 18b from the ICs 14a and 14b, respectively, as shown in FIG. 9, the guide rollers 23a and 23b are lowered to thereby separate the first protective tape 18a from the pressing part 1a of the first pressure bonding tool 1 (S9), and the guide rollers 30a and 30b are raised to thereby separate the second protective tape 18b from the pressing part 2a of the second pressure bonding tool 2 (S10). Thereafter, the work item 11 is removed from the area between the first and second pressure bonding tools 1 and 2 (S11), and thus the series of mounting steps ends.

After the removal of the work item 11 from the area between the first and second pressure bonding tools 1 and 2, the first and second feed rollers 20 and 27 and the first and second suction fans 22 and 29 are driven. The portion of the first protective tape 18a, used for the pressure bonding, is conveyed toward the first storage case 21 by the drive of the first feed rollers 20 and then sucked and stored in the first storage case 21 by the drive of the first suction fan 22.

When the portion of the first protective tape 18a used for the pressure bonding is conveyed toward the first storage case 21 by the drive of the first feed rollers 20, the first protective tape 18a held on the first holding shaft 19 is drawn such that an unused portion of the first protective tape 18a is moved to the area between the first and second pressure bonding tools 1 and 2 in order to be ready for a subsequent pressure bonding.

The portion of the second protective tape 18b used for the pressure bonding is conveyed toward the second storage case 28 by the drive of the second feed rollers 27 and then sucked and stored in the second storage case 28 by the drive of the second suction fan 29.

When the portion of the second protective tape 18b used for the pressure bonding is conveyed toward the second storage case 28 by the drive of the second feed rollers 27, the second protective tape 18b held on the second holding shaft 26 is drawn such that an unused portion of the second protective tape 18b is moved to the area between the first and second pressure bonding tools 1 and 2 in order to be ready for a subsequent pressure bonding.

According to the double-sided mounting apparatus A1, the used portions of the first and second protective tapes 18a and 18b are sucked into and stored in the first and second storage cases 21 and 28, respectively. This eliminates the need for a mechanism to take up the used portions of the first and second protective tapes 18a and 18b. Accordingly, the devices for storing the used first and second protective tapes 18a and 18b can be simplified.

In addition, this eliminates the need for time and effort, for example, to wind the leading ends of the first and second protective tapes 18a and 18b around corresponding take-up shafts in the first and second storage cases 21 and 28 after the used first and second protective tapes 18a and 18b have been taken up from the first and second storage cases 21 and 28 respectively and disposed of. Accordingly, this reduces time and effort needed after the used first and second protective tapes 18a and 18b have been taken out from the first and second storage cases 21 and 28 respectively and disposed of.

### Second Embodiment

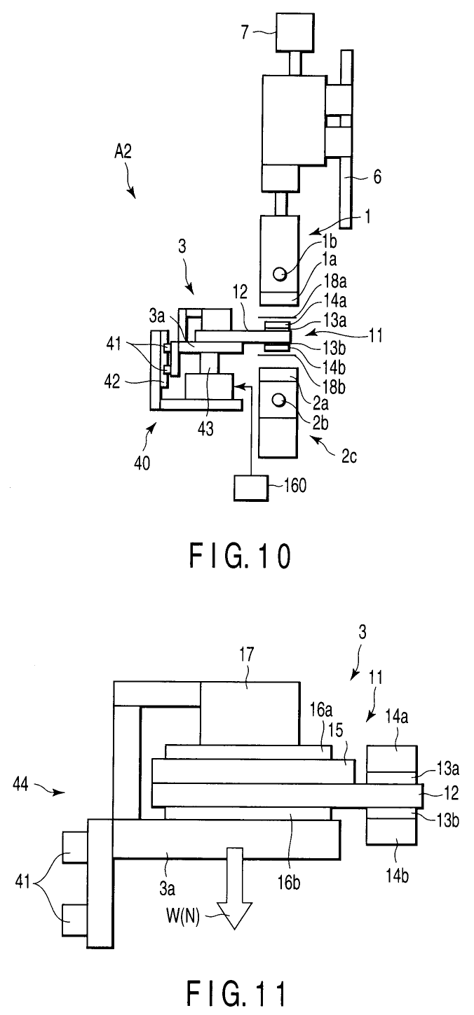

A double-sided mounting apparatus A2 according to the second embodiment of the present invention will now be described with reference to FIGS. 10 to 15. Reference numbers identical to those in the first embodiment are used for elements identical to those in the first embodiment and explanations thereof will be omitted.

The basic configuration of the double-sided mounting apparatus A2 according to the second embodiment is identical to that according to the first embodiment. The double-sided mounting apparatus A2 according to the second embodiment differs from that (A1) according to the first embodiment in the following respect: a work holding mechanism 3 incorporated in the double-sided mounting apparatus A2 includes a weight canceling mechanism 40 that effectively cancels out the weight of a work item 11 held by the mechanism 3. The weight canceled out by the mechanism 40 includes, in addition to the weight of the work item 11, the weight of a member moved while holding the work item 11.

Direct movement guides 41 are connected to a holding stage 3a, which composes part of the work holding mechanism 3. The direct movement guides 41 slidably engage with a vertically extending guide rail 42 fixed in position. An air cylinder 43 is connected to the underside of the holding stage 3a. Connected to the air cylinder 43 is an electro-pneumatic regulator 160. Air supplied to the air cylinder 43 from the electro-pneumatic regulator 160 is freely set to an arbitrary pressure. The weight canceling mechanism 40 includes the air cylinder 43, electro-pneumatic regulator 160, and direct movement guides 41.

FIG. 11 is a side view of a raising/lowering part 44 the weight of which is canceled out by the weight canceling mechanism 40. The weight W(N) of the raising/lowering part 44 includes the sum of the weight of the holding stage 3a, the weights of the direct movement guides 41, the weight of the work clamper 17, and the weight of the work item 11.

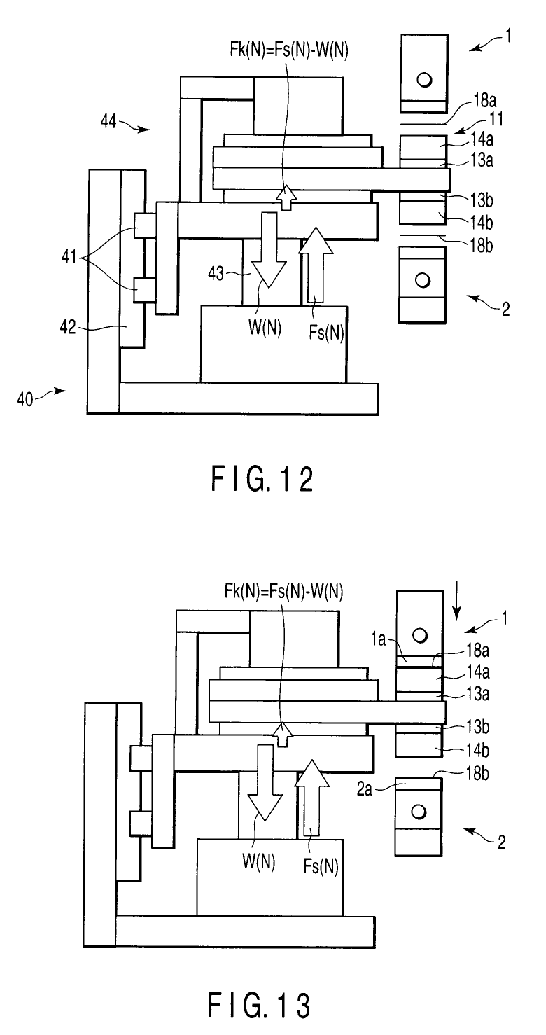

FIG. 12 shows a state before pressure is applied to each of the ACFs 13a and 13b. The downward force W(N) acts on the raising/lowering part 44. Therefore, the force W(N) induces the raising/lowering part 44 to move downward. To avoid this, air pressure is supplied to the air cylinder 43 such that upward thrust Fs(N) is exerted from the air cylinder 43.

At this time, upward force Fk(N) acting on the raising/lowering part 44 is Fk(N)=Fs(N)−W(N). Adjusting the pressure supplied to the air cylinder 43 so as to obtain Fs(N)=W(N) results in Fk(N)=0(N), thereby canceling out the weight of the raising/lowering part 44.

For convenience, this state is referred to as a weight canceled state. The raising/lowering part 44 in the weight canceled state is moving neither upward nor downward.

FIG. 13 shows the state in which, as a result of the lowering of the first pressure bonding tool 1, the pressing part 1a is in contact with the IC 14a of the work item 11 via the first protective tape 18a. Incidentally, the pressing part 1a has just come into contact with the IC 14a and no downward force has been applied to the IC 14a by the first pressure bonding tool 1.

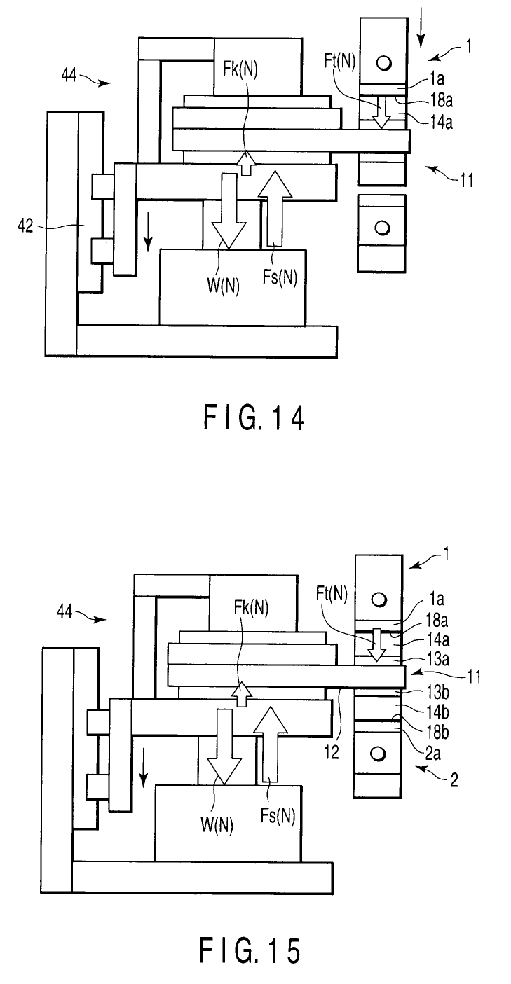

FIG. 14 shows the state in which, after the pressing part 1a of the first pressure bonding tool 1 has brought into contact with the IC 14a via the first protective tape 18a, the first pressure bonding tool 1 is further lowered. At this time, downward force Ft (N) is applied to the work item 11 by the first pressure bonding tool 1. Consequently, the raising/lowering part 44 slides downward along the guide rail 42. However, the raising/lowering part 44 slides downward only when the following condition is satisfied: Ft(N)>Fs(N)−W(N)=Fk(N).

FIG. 15 shows the state in which, as a result of further lowering the first pressure bonding tool 1 from the state shown in FIG. 14, the IC 14b disposed on the underside (i.e., lower surface) of the work item 11 is in contact with the pressing part 2a of the second pressure bonding tool 2 via the second protective tape 18b. In this state, the ICs 14a and 14b are sandwiched between the first and second pressure bonding tools 1 and 2 such that pressures are applied to the corresponding ICs.

These pressures act on the upper and lower ACFs 13a and 13b, which consequently cause thermoplastic reactions under pressure and heat applied thereto. Thus, the mounting of the ICs 14a and 14b by use of the ACFs 13a and 13b is completed. Strictly speaking, the force acting on the ACF 13a is Ft(N)+Nk(N), and the force acting on the ACF 13b is Ft(N)−Fk(N).

From the two formulas, it is apparent that different pressures act on the upper and lower ACFs 13a and 13b during the pressure bonding operation. However, when the pressure and temperature for the upper pressure bonding conditions and those for the lower pressure bonding conditions are closer, the thermoplastic reactions caused by the upper and lower ACFs 13a and 13b yield almost the same result. It is, therefore, desirable that the upper pressure and the lower pressure be as equal as possible. Accordingly, in order to apply equal force to the upper and lower ACFs 13a and 13b, it is preferable that Fk(N)≈0, that is, Fs(N)≈W(N). In other words, it is preferable that the weight of the raising/lowering part 44 is canceled. Thus, it is necessary to provide the weight canceling mechanism 40, as shown in FIG. 10.

On the other hand, when Fk(N)≠0, the mounting base 12 in the state shown in FIG. 15 is subject to Fk(N) shearing force. If Fk(N) is great, the mounting base 12 may be damaged. In this case also, a mechanism to obtain Fk(N)≈0, namely the weight canceling mechanism 40, is necessary.

### Third Embodiment

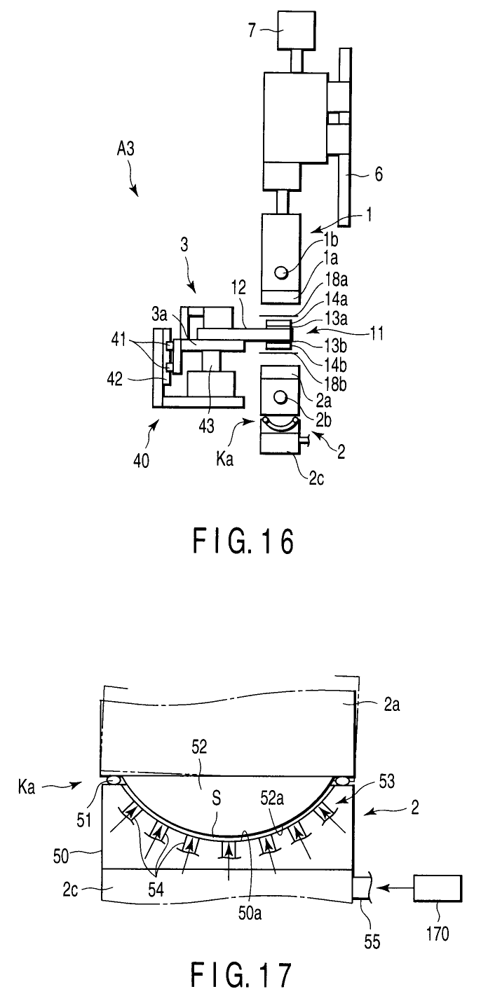

A double-sided mounting apparatus A3 according to the third embodiment of the present invention will now be described with reference to FIGS. 16 to 18. Reference numbers identical to those in the second embodiment are used for elements identical to those in the second embodiment and explanations thereof will be omitted.

The basic configuration of the double-sided mounting apparatus A3 according to the third embodiment is the same as that (A2) according to the second embodiment. Accordingly, as in the second embodiment, the double-sided mounting apparatus A3 has a weight canceling mechanism 40, which cancels out the weight of a work item 11 held by the work holding mechanism 3. The weight canceling mechanism 40 may be used as it is in the double-sided mounting apparatus A1 described in the first embodiment.

The double-sided mounting apparatus A3 according to the third embodiment is distinguished from the double-sided mounting apparatuses A1 and A2 according to the first and second embodiments by a floating mechanism Ka (described below) incorporated in a second pressure bonding stage 2.

FIG. 16 is a schematic side view of the double-sided mounting apparatus A3, and FIG. 17 is a view schematically showing the configuration of the floating mechanism Ka provided in the second pressure bonding stage 2.

The second pressure bonding stage 2 has: a second pressing part 2a disposed opposite the first pressing part 1a of a first pressure bonding tool 1; and a heating means, namely a heater 2b. As in the first and second embodiments, the heater 2b is disposed so that the heat generated by the heater 2b is transmitted to the second pressing part 2a. Since the heater 2b is integrated with the second pressing part 2a, the heater 2b is also hereinafter referred to as the second pressing part 2a.

The floating mechanism Ka is disposed between the second pressing part 2a and a pedestal 2c. A commercially available spherical bearing is used in this floating mechanism Ka. To be specific, the floating mechanism Ka includes: a receiving base 50 placed on the pedestal 2c; an inclinable part 52 supported on the receiving base 50 via a sealing member 51; and an air supply mechanism 53 connected to the area between the receiving base 50 and the inclinable part 52.

The receiving base 50 has on its upper surface a concave area 50a, in the shape of a segment of a hollow sphere, and is fixed on a base together with the pedestal 2c. The sealing member 51, which is formed from a rubber packing material and has an annular shape, is stuck and fixed along the circular edge of the concave area 50a defined in the receiving base 50. The inclinable part 52 is supported on the sealing member 51.

Defined on the underside (i.e., lower surface) of the inclinable part 52 is a spherical part 52a that has such a degree of curvature radius that a narrow empty space (about 0.1 mm) S is left between the concave area 50a of the receiving base 50 and the spherical part. The sealing member 51 is disposed between the circular edge of the spherical part 52a of the inclinable part 52 and the circular edge of the concave area 50a of the receiving base 50. The spherical part 52a of the inclinable part 52 is fitted in the concave area 50a of the receiving base 50 via the empty space S. The inclinable part 52 is supported so as to be freely inclinable relative to the receiving base 50.

Additionally, the floating mechanism Ka includes the above-mentioned air supply mechanism 53 that supplies high-pressure air to the empty space S between the spherical part 52a of the inclinable part 52 and the concave area 50a of the receiving base 50. Specifically, a plurality of holes are made in the concave area 50a of the receiving base 50, and pipes 54 are connected to the holes toward the center of the sphere formed by the concave area 50a and spherical part 52a. Each pipe 54 branches off a main pipe 55 attached to the pedestal 2c. The main pipe 55 extends from a second pressure bonding tool 2 and is connected to a high pressure air pump 170 disposed outside of the mounting apparatus.

When the double-sided mounting apparatus A3 is running, the high-pressure air pump 170 is constantly operated such that high pressure air is conveyed from the main pipe 55 to each pipe 54 and supplied to the space S between the receiving base 50 and inclinable part 52. The inclinable part 52 is in the state of floating on air. Needless to say, the double-sided mounting apparatus A3 is provided with a means such that when no load (i.e., no pressure) is applied by the second pressure bonding tool 2 to the inclinable part 52, the inclinable part 52 is prevented from moving apart from the receiving base 50 or thereby causing a leakage of high-pressure air from the periphery of the sealing member 51. In other words, the inclinable part 52 is effectively supported by a so-called air spring.

In the double-sided mounting apparatus A3 having the foregoing floating mechanism Ka, the pressing part 1a of the first pressure bonding tool 1 is lowered and brought into contact with the upper face of a work item 11 via a first protective tape 18a, as described with reference to FIGS. 10 to 14.

At this time, even if the levelness of the work item 11 is not ensured, such as when the upper surface of the work item 11 is not in a horizontal position, a work clamper 17 has a mechanism that corrects the inclination of the upper surface of the work item 11 by aligning it with the first pressure bonding tool 1 so that the work item 11 is disposed along the contact face of the first pressure bonding tool 1 with the work item 11.

Alternatively, a holding stage 3a may be provided with a mechanism that corrects the inclination of the upper surface of the work item 11 by aligning it with the first pressure bonding tool 1 while a polarization plate 16b for the work item 11 adheres to the holding stage 3a, as shown in FIG. 3A, thereby disposing the work item 11 along the contact face of the first pressure bonding tool 1 with the work item 11.

The first pressure bonding tool 1 is lowered while the levelness of the upper surface of the work item 11 is regulated. Finally the lower surface of the work item 11 comes into contact with the second pressure bonding tool 2, as shown in FIG. 15. Simultaneously with this, the weight canceling mechanism 40 acts to cancel out the weight of the work item 11 and the weight of the raising/lowering part 44. When the first pressure bonding tool 1 is further lowered, the work item 11 is sandwiched and pressed between the first and second pressure bonding tools 1 and 2 via the first and second protective tapes 18a and 18b.

As long as parallel flatness of the upper and lower surfaces of the work item 11 is ensured, the entire lower surface comes into contact with the second pressure bonding tool 2. The second pressure bonding tool 2 applies pressure to the work item 11 so as to sandwich the work item between the first pressure bonding tool 1 and the tool 2 itself. Accordingly, uniform pressure can be applied to the entire upper and lower surfaces of the work item 11.

Actually, the mounting base 12 composing the work item 11 is formed from a plate of glass, and absolute parallel flatness of the plate is not obtained. Moreover, the work item 11 is configured such that an IC 14a sealed with a resin material is temporarily fastened to the upper surface of the mounting base 12 via a tape of ACF 13a and, similarly, an IC 14b is temporarily fastened to the underside of the mounting base 12 via an ACF 13b made of the same material as the ACF 13a. Therefore, the lower surface of the work item 11 is usually inclined at an angle to the upper surface of the work item 11.

In the double-sided mounting apparatuses A1 and A2 according to the first and second embodiments respectively, the second pressing part 2a of the second pressure bonding tool 2 is fixed in position. Accordingly, if the work item 11, with its lower surface inclining, is lowered onto the second pressing part 2a, the lower surface may come partially into contact with the pressing part 2a even though the upper surface of the work item 11 is in a horizontal position. Applying pressure in this state results in uneven application of pressure and heat.

However, the double-sided mounting apparatus A3 according to the third embodiment supports the second pressing part 2a on the pedestal 2c via the floating mechanism Ka. Therefore, if the work item 11, with its lower surface inclined relative to the upper surface, is brought into contact with the second pressure bonding tool 2, the inclinable part 52 composing the floating mechanism Ka inclines as the lower surface of the work item 11 inclines.

Specifically, the sealing member 51 is disposed between the inclinable part 52 and the receiving base 50 and, in addition, high-pressure air is supplied from the air supply mechanism 53 to the space S between the inclinable part 52 and the receiving base 50. Consequently, the resistance of the inclinable part 52 to sliding over the receiving base 50 is extremely small, so that the inclinable part 52 is smoothly moved following the lower surface of the work item 11.

In this condition, pressure and heat are applied to both sides of the work item 11 and, consequently, the ICs 14a and 14b are mounted on the upper and lower surfaces of the mounting base 12 via the ACFs 13a and 13b, respectively. The high-pressure air supplied to the empty space S between the inclinable part 52 and receiving base 50 during the application of pressure prevents compression of the sealing member 51, thus ensuring the smooth movement of the inclinable part 52.

When the pressure bonding on both sides of the work item 11 is completed, the first pressure bonding tool 1 having the first pressing part 1a and the first protective tape supply mechanism 4 are raised. Also, the work item 11 and the second protective tape supply mechanism 5 are raised and separated from the second pressing part 2a of the second pressure bonding tool 2. If the lower surface of the work item 11 is inclined, the second pressing part 2a holds a position that follows the inclination of the lower surface of the work item 11.

Even if a subsequent work item 11 to be mounted is guided to the double-sided mounting apparatus A3 and the lower surface of this work item 11 happens to incline in a direction different from the lower surface of the previous work item 11, the inclinable part 52 smoothly follows the inclination of the lower surface of the work item 11 moved downward. Accordingly, high-pressure air supplied to the empty space S between the inclinable part 52 and the receiving base 50 absorbs shock, thereby preventing damage to the work item 11 and the inclinable part 52 which may occur when the lower surface of the work item 11 comes into contact with the inclinable part 52.

As described above, the second pressure bonding tool 2 uniformly supports the entire lower surface of the work item 11, making it possible to evenly apply pressure and heat to the entire surfaces of both the sides of the work item 11.

Incidentally, the double-sided mounting apparatus A3 may include a return mechanism, which is designed such that if the inclinable part 52 is in an inclined position after the double-sided mounting on the work item 11 is completed and the work item 11 and the second protective tape supply mechanism 5 are separated from the second pressing part 2a, then the inclinable part 52 is brought back to a horizontal position during the guide of a subsequent work item 11.

Examples of such a mechanism include a return mechanism that has a plurality of protruding rods disposed so as to freely poke the inclinable part 52 from the receiving base 50 and freely retract therefrom. The return mechanism is capable of controlling the degree to which the inclinable part 52 is poked by each rod, according to a detection signal from an inclination sensor, thereby accurately correcting the levelness of the inclinable part 52.

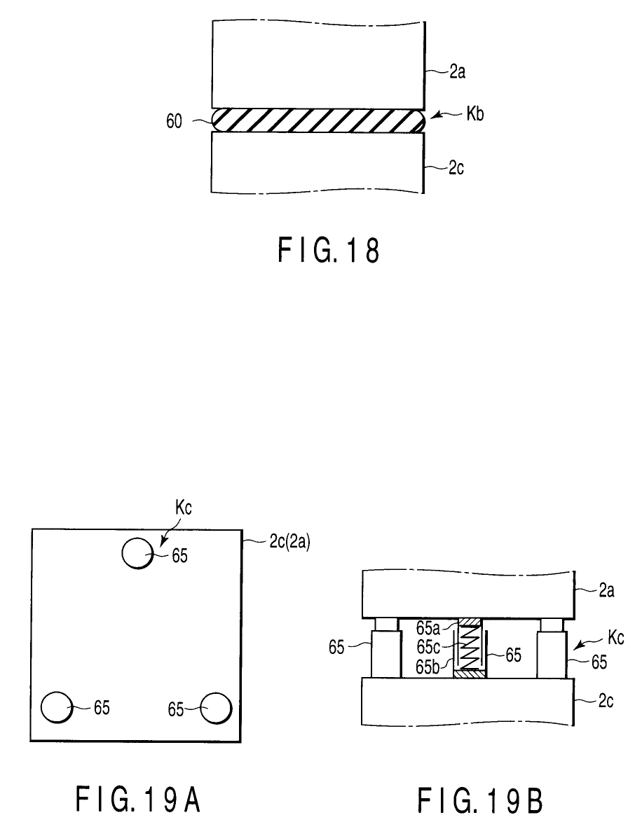

FIG. 18 shows a floating mechanism Kb as a modified example of the third embodiment.

This floating mechanism Kb consists of a flat rubber plate 60 interposed between the pedestal 2c and the second pressing part 2a. If the lower surface of the work item 11 inclines, the floating mechanism Kb, namely the rubber plate 60, is elastically deformed following the inclination. This makes it possible to constantly and uniformly support the entire lower surface of the work item 11, ensuring the even application of pressure and heat to both sides of the work item 11 and hence the mounting of ICs 14a and 14b on both the upper and lower surfaces of a mounting base 12 via ACFs 13a and 13b.

The rubber plate 60 serving as the floating mechanism Kb has a simple configuration in comparison with the above-described floating mechanism Ka that includes the receiving base 50, inclinable part 52, and air supply mechanism 53. In addition, when the work item 11 is detached from the second pressure bonding tool 2 after the completion of mounting the ICs 14a and 14b on both sides of the work item 11, the rubber plate 60 immediately returns to its original flat shape by virtue of its elasticity.

If the lower surface of a subsequent work item 11 to be subject to double-sided mounting inclines, the rubber plate 60 follows the inclination and uniformly supports the entire lower surface. On the other hand, if the lower surface of the work item 11 does not incline, the rubber plate 60 uniformly supports the entire lower surface.

FIG. 19A is a plan view of a floating mechanism Kc as another modified example of the third embodiment. FIG. 19B is a partial sectional view of the floating mechanism Kc shown in FIG. 19A.

This floating mechanism Kc includes three plungers 65 elastically supporting the second pressing part 2a on the pedestal 2c. Each plunger 65 includes: an internal cylindrical part 65a attached to the second pressing part 2a; an external cylindrical part 65b attached to the pedestal 2c so that the leading end of the external cylindrical part 65b freely and slidably fits around the internal cylindrical part 65a; and a compression coil spring 65c accommodated inside the internal and external cylindrical parts 65a and 65b. This floating mechanism Kc supports the second pressing part 2a at three points on the pedestal 2c.

If the lower surface of the work item 11 inclines, the compression coil spring 65c of each plunger 65 is compressed and elastically deformed according to the degree of inclination, so that the second pressing part 2a receiving the work item 11 inclines following the lower surface of the work item 11.

The floating mechanism Kc enables the second pressing part 2a to uniformly support the entire lower surface of the work item 11. This ensures the application of pressure and heat to both sides of the work item 11 and hence the mounting of ICs 14a and 14b on both the upper and lower surfaces of the mounting base 12 via ACFs 13a and 13b.

This floating mechanism Kc has a simple configuration in comparison with the above-described floating mechanism Ka including the receiving base 50, inclinable part 52, and air supply mechanism 53. In addition, when the work item 11 is detached from the second pressure bonding tool 2 after the completion of double-sided mounting on the work item 11, the mechanism Kc immediately returns to its original horizontal position by virtue of its elasticity.

If the lower surface of a subsequent work item 11 to be subject to double-sided mounting inclines, the floating mechanism Kc follows the inclination. On the other hand, if the lower surface of the work item does not incline, the mechanism Kc nevertheless uniformly supports the entire lower surface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A double-sided mounting apparatus, comprising:
a first pressure bonding tool and a second pressure bonding tool disposed opposite to each other;
heating means for heating the first pressure bonding tool and the second pressure bonding tool;
pressing means for applying pressure to an area between the first pressure bonding tool and the second pressure bonding tool;
a work holding mechanism which holds a work item between the first and second pressure bonding tools;
a first protective tape supply mechanism disposed between the first and second pressure bonding tools and used to supply a first protective tape to the first pressure bonding tool; and
a second protective tape supply mechanism disposed between the first and second pressure bonding tools and used to supply a second protective tape to the second pressure bonding tool.

2. The double-sided mounting apparatus according to claim 1, wherein the work holding mechanism includes a weight canceling mechanism which cancels out a weight of the held work item.

3. The double-sided mounting apparatus according to claim 1, wherein the first protective tape supply mechanism includes a first supply part which supplies the first protective tape and a first suction part which draws the supplied first protective tape into a first storage case, and
the second protective tape supply mechanism includes a second supply part which supplies the second protective tape and a second suction part which draws the supplied second protective tape into a second storage case.

4. The double-sided mounting apparatus according to claim 2, wherein the first protective tape supply mechanism includes a first supply part which supplies the first protective tape and a first suction part which draws the supplied first protective tape into a first storage case, and
the second protective tape supply mechanism includes a second supply part which supplies the second protective tape and a second suction part which draws the supplied second protective tape into a second storage case.

5. The double-sided mounting apparatus according to claim 1, wherein the first pressure bonding tool includes a first pressing part lowered from above the work item and coming into contact with the upper surface of the work item, and
the second pressure bonding tool includes a pedestal disposed in an installation area, a second pressing part which supports the lower surface of the work item lowered as a result of its being pressed by the first pressure bonding tool, and a floating mechanism disposed between the second pressing part and the pedestal and used to incline the second pressing part such that the second pressing part inclines following the inclination of the lower surface of the work item.

6. The double-sided mounting apparatus according to claim 5, wherein the floating mechanism includes:
a fixed receiving base mounted on the pedestal and provided with a spherical concave area in the upper surface thereof;
a sealing member disposed along a circular edge of the concave area of the receiving base;
an inclinable part attached to the second pressing part, supported on the receiving base via the sealing member so as to be freely inclinable, and having a spherical part fitted in the concave area of the receiving base such that an empty space is left between the spherical part and the concave area; and
an air supply mechanism which supplies high-pressure air to the empty space between the spherical part of the inclinable part and the concave area of the receiving base.

7. The double-sided mounting apparatus according to claim 5, wherein the floating mechanism is a flat plate of rubber.

8. The double-sided mounting apparatus according to claim 5, wherein the floating mechanism is a plunger which elastically supports the second pressing part at three points.

9. An electric device manufacturing method comprising:
a step of temporarily fastening a first electronic component to a surface of a mounting base via a first anisotropic conductive adhesive, and temporarily fastening a second electronic component to the back of the mounting base, which is opposite to the surface, via a second anisotropic conductive adhesive;
a step of disposing a first protective tape opposite to the first electronic component temporarily fastened, and disposing a second protective tape opposite to the second electronic component temporarily fastened; and
a step of applying heat and pressure to the first anisotropic conductive adhesive via the first protective tape and the first electronic component, and applying heat and pressure to the second anisotropic conductive adhesive via the second protective tape and the second electronic component, thereby connecting the first and second electronic components to the surface and back, respectively, of the mounting base.

10. An electric device manufacturing method according to claim 9, wherein the mounting base held by a work holding mechanism.

11. An electric device manufacturing method according to claim 10, wherein the work holding mechanism includes a weight canceling mechanism which cancels out a weight of the held mounting base.

12. An electric device manufacturing method according to claim 9, wherein the first protective tape supplied by a first protective tape supply mechanism and the second protective tape supplied by a second protective tape mechanism,
the first protective tape supply mechanism includes a first supply part which supplies the first protective tape and a first suction part which draws the supplied first protective tape into a first storage case, and
the second protective tape supply mechanism includes a second supply part which supplies the second protective tape and a second suction part which draws the supplied second protective tape into a second storage case.

13. An electric device manufacturing method according to claim 9, wherein the first protective tape supplied by a first protective tape supply mechanism and the second protective tape supplied by a second protective tape mechanism,
the first protective tape supply mechanism includes a first supply part which supplies the first protective tape and a first suction part which draws the supplied first protective tape into a first storage case, and
the second protective tape supply mechanism includes a second supply part which supplies the second protective tape and a second suction part which draws the supplied second protective tape into a second storage case.
